(19) United States
(12) Patent Application Publication
(10) Pub. No.: US 2024/0251781 A1
(43) Pub. Date: Aug. 1, 2024

(54) Deer Scent Spraying Device

(71) Applicant: Ephriam Jones, Mount Pleasant, WI (US)

(72) Inventor: Ephriam Jones, Mount Pleasant, WI (US)

(21) Appl. No.: 18/508,509

(22) Filed: Nov. 14, 2023

Related U.S. Application Data
(60) Provisional application No. 63/441,252, filed on Jan. 26, 2023.

(51) Int. Cl. A01M 31/00

(52) U.S. Cl. CPC A01M 31/008

(57) ABSTRACT

A deer scent spraying device is provided. The device is designed to spray an aerosol compound, such as, but not limited to, doe estrus or buck urine, from at least one spray can of the device at a timed interval into the surrounding environment. This allows a hunter to ensure said compound is continuously present in said environment to attract deer to said area while hunting. The timed interval may be selected by a button on the device or via a mobile application in wireless electrical communication with the device.

### CROSS-REFERENCE TO RELATED APPLICATION

The present application claims priority to, and the benefit of, U.S. Provisional Application No. 63/441,252, which was filed on Jan. 26, 2023, and is incorporated herein by reference in its entirety.

### FIELD OF THE INVENTION

The present invention relates generally to the field of hunting. More specifically, the present invention relates to a deer scent spraying device that sprays doe estrus or buck urine into a surrounding area at timed intervals to ensure the constant presence of said compounds in said area. Accordingly, the present disclosure makes specific reference thereto. Nonetheless, it is to be appreciated that aspects of the present invention are also equally applicable to other like applications, devices, and methods of manufacture.

### BACKGROUND

Deer possess an extraordinary ability to detect the presence of other deer from astonishing distances, sometimes spanning several miles, via scent. When this occurs, deer gain the perception that the surrounding area is secure and suitable for further exploration. In an attempt to emulate this phenomenon, hunters have developed various techniques to attract deer by employing scents such as buck urine or doe estrus.

Traditionally, hunters have relied on conventional dispensing methods to distribute these scents across a hunting area. However, one significant drawback of these methods is the rapid dissipation of the scent, diminishing its effectiveness over time. As a solution, some hunters have turned to using wick sticks infused with potent doe estrus, allowing for a more controlled and sustained release of the scent. Yet even this method has encountered its own set of challenges, particularly when faced with freezing temperatures. In colder climates, the practicality of using wick sticks dipped in doe estrus becomes compromised due to the tendency of the liquid to freeze. This unfortunate consequence impedes the proper dispersal of the scent, rendering the method less reliable during frigid hunting expeditions.

Therefore, there exists a long-felt need in the art for a device that allows a hunter to easily spray deer scent. More specifically, there exists a long-felt need in the art for a deer scent spraying device that allows a hunter to spray deer scent at specific intervals to ensure said scent is continuously present in a hunting area. In addition, there exists a long-felt need in the art for a deer scent spraying device that allows a hunter to spray deer scent at specific intervals to ensure said scent is continuously present in a hunting area and wherein the device can conveniently attach to nearby structures.

The subject matter disclosed and claimed herein, in one embodiment thereof, comprises a deer scent spraying device. The device is designed to spray an aerosol compound, such as, but not limited to, doe estrus or buck urine, from at least one spray can of the device (via a motor) at a timed interval into the surrounding environment. This allows a hunter to ensure said compound is continuously present in the said environment to attract deer to said area while hunting. The timed interval may be selected by a button on the device or via a mobile application in wireless electrical communication with the device. In addition, the device can be easily attached to nearby trees or other structures via at least one strap or other fastening method of the like.

In this manner, the deer scent spraying device of the present invention accomplishes all the foregoing objectives and provides a device that allows a hunter to easily spray deer scent. More specifically, the device allows a hunter to spray deer scent at specific intervals to ensure said scent is continuously present in a hunting area. While doing so, the device can conveniently attach to nearby structures.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a deer scent spraying device. The device is designed to spray an aerosol compound, such as, but not limited to, doe estrus or buck urine, from at least one spray can of the device at a timed interval into the surrounding environment. This allows a hunter to ensure said compound is continuously present in the said environment to attract deer to said area while hunting.

The device is comprised of a body preferably having any camouflage or hunting pattern known in the art to allow the device to blend in with a wilderness environment. The body can be removably attached around a tree or other structure (ex. a hunting blind) during use via at least one strap. The strap can be wrapped around a tree and secured to itself via at least one fastener positioned on the strap such as, but not limited to, hook and loop, snap button, magnet, etc.

The body is also comprised of an interior space that can be accessed via at least one door that attaches to the body via at least one hinge. The door can be secured to the body during use with at least one lock to prevent unauthorized users and/or animals from entering the interior space. The interior space houses at least one spray can or other similar aerosol compound holding and dispensing structure of the like. The spray can store at least one aerosol compound used to attract deer, such as, but not limited to, buck urine or doe estrus. The compound is then sprayed from the can and out of the body via at least one opening in the body using at least one motor.

The compound may be sprayed at specifically timed intervals, such as, but not limited to, 10 minutes, 15 minutes, 20 minutes, 30 minutes, etc. This ensures the compound continuously is present in the surrounding area to attract deer. The spraying interval may be selected by pressing at least one button positioned anywhere on or in the device.

In one embodiment, the spraying of the compound from the can via the motor can be controlled via a mobile application. The mobile application allows a user to turn the motor on/off and select the timing interval of spraying the compound. In this manner, a user need not be physically present at the location of the device to begin spraying the compound.

The present invention is also comprised of a method of using the device. First, a device is provided comprised of a body comprised of a motor, and at least one spray can housing at least one spray compound. Then, the body can be secured to a structure, such as, but not limited to, a tree or hunting stand, via at least one strap. Then, at least one button of the device can be pressed to like a spraying interval at which the compound is sprayed from the can via the motor.

In another method of using the device, a device is provided comprised of a body comprised of a motor having a transmitter, at least one spray can housing at least one spray compound, and a mobile application. Then, the body can be secured to a structure, such as, but not limited to, a tree or hunting stand, via at least one strap. Then, the mobile application can be used to select a spraying interval at which the compound is sprayed from the can via the motor.

Accordingly, the deer scent spraying device of the present invention is particularly advantageous as it provides a device that allows a hunter to easily spray deer scent. More specifically, the device allows a hunter to spray deer scent at specific intervals to ensure said scent is continuously present in a hunting area. While doing so, the device can conveniently attach to nearby structures. In this manner, the deer scent spraying device overcomes the limitations of existing methods of spraying deer scent known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a deer scent spraying device of the present invention while attached to a tree in accordance with the disclosed architecture;

FIG. 2 illustrates an enhanced perspective view of an interior space of one potential embodiment of a deer scent spraying device of the present invention in accordance with the disclosed architecture;

FIG. 3 illustrates a graphical view of a mobile application of one potential embodiment of a deer scent spraying device of the present invention in accordance with the disclosed architecture;

FIG. 4 illustrates a flowchart of a method of using one potential embodiment of a deer scent spraying device of the present invention in accordance with the disclosed architecture; and

FIG. 5 illustrates a flowchart of a method of using one potential embodiment of a deer scent spraying device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof.

It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a hunter to easily spray deer scent. More specifically, there exists a long-felt need in the art for a deer scent spraying device that allows a hunter to spray deer scent at specific intervals to ensure said scent is continuously present in a hunting area. In addition, there exists a long-felt need in the art for a deer scent spraying device that allows a hunter to spray deer scent at specific intervals to ensure said scent is continuously present in a hunting area and wherein the device can conveniently attach to nearby structures.

The present invention, in one exemplary embodiment, is comprised of a deer scent spraying device designed to spray an aerosol compound, such as, but not limited to, doe estrus or buck urine, from at least one spray can of the device at a timed interval into the surrounding environment. This allows a hunter to ensure said compound is continuously present in the said environment to attract deer to said area while hunting.

The device is comprised of a body. The body may have any camouflage or hunting pattern known in the art to allow the device to blend in with a wilderness environment. The body can be removably attached around a tree or other structure (ex. a hunting blind) during use via at least one strap. The strap can be wrapped around a tree and secured to itself via at least one fastener positioned on the strap such as, but not limited to, hook and loop, snap button, magnet, etc.

The body is also comprised of an interior space. The interior space can be accessed via at least one door that attaches to the body via at least one hinge. The door can be secured to the body during use with at least one lock to prevent unauthorized users and/or animals from entering the interior space.

The interior space houses at least one spray can or other similar aerosol compound holding and dispensing structure of the like. The spray can store at least one aerosol compound used to attract deer. Said compound may include buck urine or doe estrus. The compound is then sprayed from the can and out of the body via at least one opening in the body using at least one motor.

The compound may be sprayed at specifically timed intervals, such as, but not limited to, 10 minutes, 15 minutes, 20 minutes, 30 minutes, etc. This ensures the compound continuously is present in the surrounding area to attract deer. The spraying interval may be selected by pressing at least one button positioned anywhere on or in the device.

In one embodiment, the spraying of the compound from the can via the motor can be controlled via a mobile application. The mobile application allows a user to turn the motor on/off and also select the timing interval of spraying the compound. In this manner, a user need not be physically present at the location of the device to begin spraying the compound.

The present invention is also comprised of a method of using the device. First, a device is provided comprised of a body comprised of a motor, and at least one spray can housing at least one spray compound. Then, the body can be secured to a structure, such as, but not limited to, a tree or hunting stand, via at least one strap. Then, at least one button of the device can be pressed to like a spraying interval at which the compound is sprayed from the can via the motor.

In another method of using the device, a device is provided comprised of a body comprised of a motor having a transmitter, at least one spray can housing at least one spray compound, and a mobile application. Then, the body can be secured to a structure, such as, but not limited to, a tree or hunting stand, via at least one strap. Then, the mobile application can be used to select a spraying interval at which the compound is sprayed from the can via the motor.

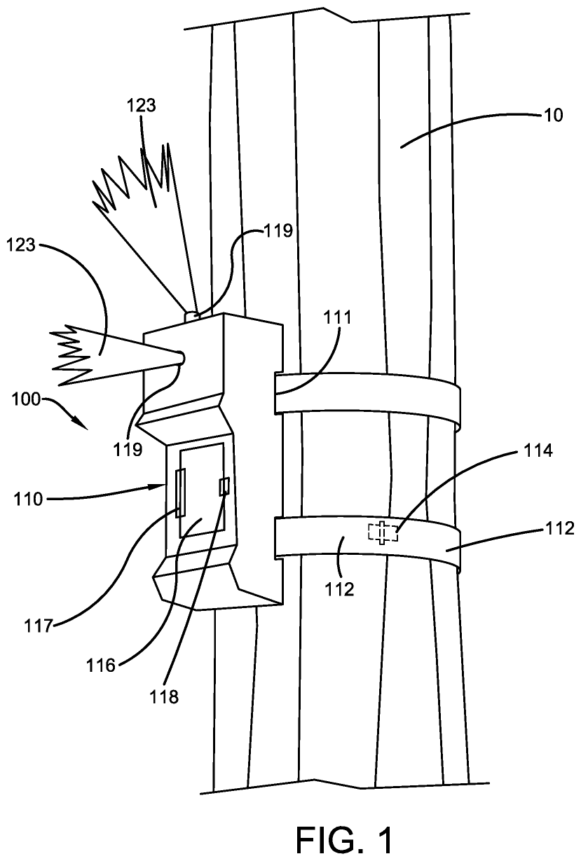

Referring initially to the drawings, FIG. 1 illustrates a perspective view of one potential embodiment of a deer scent spraying device 100 of the present invention while attached to a tree 10 in accordance with the disclosed architecture. The device 100 is designed to spray an aerosol compound 123, such as, but not limited to, doe estrus or buck urine, from at least one spray can 122 of the device 100 at a timed interval into the surrounding environment. This allows a hunter to ensure said compound 123 is continuously present in said environment to attract deer to said area while hunting.

The device 100 is comprised of a body 110 which may be any shape known in the art. The body 110 is preferably comprised of any camouflage or hunting pattern (indicia 115) known in the art to allow the device 100 to blend in with a wilderness environment.

The body 110 can be removably attached around a tree 100 or other structure (ex. a hunting blind) during use. To do so, the body 110 may be comprised of at least one strap opening 111 or other receiving structure of the like that receives at least one strap 112. The strap 112 can be wrapped around a tree 10 and secured to itself via at least one fastener 114 positioned on the strap 112 such as, but not limited to, hook and loop, snap button, magnet, etc. The strap 112 may also be comprised of any camouflage or hunting pattern (indicia 115) known in the art to allow the device 100 to blend in with a wilderness environment.

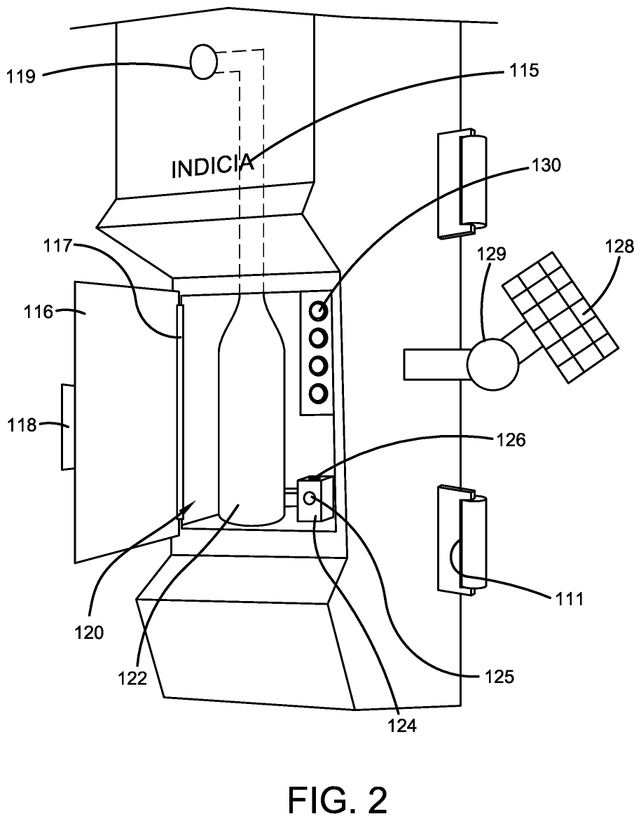

The body 110 is comprised of an interior space 120, as seen in FIG. 2. The interior space 120 can be accessed via at least one door 116 that attaches to the body 110 via at least one hinge 117 (of any type known in the art). The door 116 can be secured to the body 110 during use with at least one lock 118 of any type known in the art. The lock 118 prevents unauthorized users and/or animals from entering the interior space 120.

The interior space 120 houses at least one spray can 122 or other similar aerosol compound holding and dispensing structure of the like. The spray can 122 stores at least one aerosol compound 123 used to attract deer. Said compound may include but is not limited to buck urine or doe estrus. The compound 123 is then sprayed from the can 122 and out of the body 110 via at least one opening 119 (which is in fluid communication with the can 122) in the body 110 using at least one motor 124. In one embodiment, the device 100 has two cans 122, each holding doe estrus or buck urine.

In one embodiment, the can 122 and compound 123 can be heated by at least one heating element 150. The heating element 150 ensures the compound 123 does not freeze during use. The element 150 is preferably powered by at least one battery 126. The element 150 may be a plurality of heating types in different embodiments. This includes, but is not limited to a heating coil, a heated air blower, etc.

The compound 123 may be sprayed at specifically timed intervals, such as, but not limited to, 10 minutes, 15 minutes, 20 minutes, 30 minutes, etc. This ensures the compound 123 continuously is present in the surrounding area to attract deer. The spraying interval may be selected by pressing at least one button 130 positioned anywhere on or in the device 100.

The motor 124 may be powered by at least one battery 126. In one embodiment, the battery 126 is a removable battery of any type known in the art. In another embodiment, the battery 126 receives power from at least one solar panel 128 positioned on the exterior of the body 110.

The solar panel 128 may be any type known in the art and may be repositionable at a plurality of angles via at least one pivot point 129 for optimized energy collection.

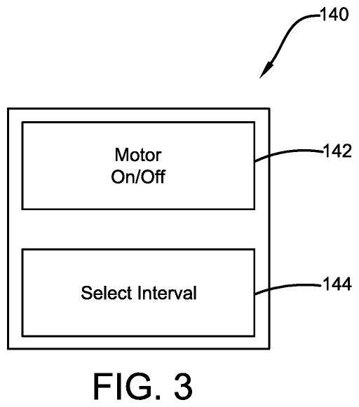

In one embodiment, the spraying of the compound 123 from the can 122 via the motor 124 can be controlled via a mobile application 140 for a smart device such as, but not limited to, a cell phone, a computer, a tablet, etc. In this embodiment, the motor 124 is comprised of at least one transmitter 125 in wireless electrical communication with the smart device of the mobile application 140 via Wi-Fi, Bluetooth, Cellular, etc. The mobile application 140 then allows a user to turn the motor 124 on/off and also select the timing interval 144 of the spraying of the compound 123, as seen in FIG. 3. In this manner, a user need not be physically present at the location of the device 100 to begin spraying the compound 123.

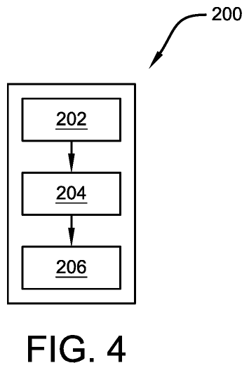

The present invention is also comprised of a method of using 200 the device 100, as seen in FIG. 4. First, a device 100 is provided comprised of a body 110 comprised of a motor 124, and at least one spray can 122 housing at least one spray compound 123 [Step 202]. Then, the body 110 can be secured to a structure, such as, but not limited to, a tree 10 or hunting stand, via at least one strap 112 or another fastener of the like [Step 204]. Then, at least one button 130 of the device 100 can be pressed to a spraying interval at which the compound 123 is sprayed from the can 122 via the motor 124 [Step 206].

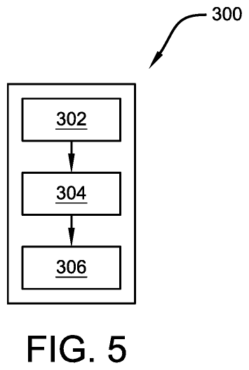

The present invention is also comprised of a method of using 300 the device 100, as seen in FIG. 5. First, a device 100 is provided comprised of a body 110 comprised of a motor 124 having a transmitter 125, at least one spray can 122 housing at least one spray compound 123, and a mobile application 140 [Step 302]. Then, the body 110 can be secured to a structure, such as, but not limited to, a tree 10 or hunting stand, via at least one strap 112 or another fastener of the like

[Step 304]. Then, the mobile application 140 can be used to select a spraying interval 144 at which the compound 123 is sprayed from the can 122 via the motor 124 [Step 306].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “deer scent spraying device” and “device” are interchangeable and refer to the deer scent spraying device 100 of the present invention.

Notwithstanding the foregoing, the deer scent spraying device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the deer scent spraying device 100 as shown in the FIGS. are for illustrative purposes only, and that many other sizes and shapes of the deer scent spraying device 100 are well within the scope of the present disclosure. Although the dimensions of the deer scent spraying device 100 are important design parameters for user convenience, the deer scent spraying device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A deer scent spraying device comprising:
a body comprised of an opening and an interior space;
a spray can be positioned within the interior space;
a compound stored within the spray can;
a motor;
a battery; and
a button.

2. A deer scent spraying device of claim 1, wherein the compound is comprised of an aerosol.

3. A deer scent spraying device of claim 2, wherein the compound is comprised of a buck urine.

4. A deer scent spraying device of claim 2, wherein the compound is comprised of a doe estrus.

5. A deer scent spraying device of claim 1, wherein the body receives a strap.

6. A deer scent spraying device of claim 5, wherein the strap is comprised of a fastener.

7. A deer scent spraying device of claim 1, wherein the motor sprays the compound from the spray can at a timed interval.

8. A deer scent spraying device of claim 7, wherein the timed interval is selected by the button.

9. A deer scent spraying device of claim 1 further comprised of a solar panel.

10. A deer scent spraying device of claim 1, wherein the body is comprised of a camouflage indicia.

11. A deer scent spraying device comprising:
a body comprised of an opening and an interior space;
a spray can be positioned within the interior space;
a compound stored within the spray can;
a motor comprised of a transmitter;
a battery; and
a mobile application.

12. A deer scent spraying device of claim 11, wherein the compound is comprised of an aerosol.

13. A deer scent spraying device of claim 12, wherein the compound is comprised of a buck urine.

14. A deer scent spraying device of claim 12, wherein the compound is comprised of a doe estrus.

15. A deer scent spraying device of claim 11, wherein the motor sprays the compound from the spray can at a timed interval.

16. A deer scent spraying device of claim 15, wherein the timed interval is selected by the mobile application.

17. A deer scent spraying device of claim 11, wherein the transmitter is in wireless electrical communication with the mobile application.

18. A method of using a deer scent spraying device, the method comprising the following steps:
providing a deer scent spraying device comprised of a motor and a spray can housing a spray compound;
attaching a body of the deer scent spraying device to a structure; and
selecting a spraying interval at which the compound is sprayed from the spray can.

19. A method of using a deer scent spraying device of claim 18 further comprised of a step of pressing a button to select the spraying interval.

20. A method of using a deer scent spraying device of claim 18 further comprised of a step of using a mobile application to select the spraying interval.
